(19) United States
(12) Patent Application Publication
(10) Pub. No.: US 2005/0146620 A1
(43) Pub. Date: Jul. 7, 2005

(54) Electronic device with image capturing and method therefor

(76) Inventors: Darrin D. Monroe, Margate, FL (US); Lamar U. Matthews, Royal Palm Beach, FL (US); Harry Point Du Jour, Lake Worth, FL (US)

Correspondence Address: Randi L. Karpinia;Motorola, Inc., Law Department, 8000 West Sunrise Boulevard, Fort Lauderdale, FL, 33322, US

(21) Appl. No.: 10/751,214

(22) Filed: Jan. 2, 2004

(51) Int. Cl. H04N 5/228; H04N 5/76

(52) U.S. Cl. 348/208.2; 348/208.3; 348/231.6

(57) ABSTRACT

An electronic device (100,200) includes an image capturing means (245) and a sensor (240), each coupled to an image manager (255). The image capturing means (245) captures an image. The sensor (240) determines an orientation of the captured image. The image manager (255) is adapted to change the orientation of the image to create a rotated image using the output of the sensor (240). The electronic device (100,200) further includes a display (230) coupled to the image manager (255) for displaying the rotated image.

### BACKGROUND OF THE INVENTION

1. Field of the Invention

The present invention is related to a portable electronic device; and more particularly to a portable electronic device with image capturing capability.

2. Description of the Related Art

Cellular telephones, messaging devices, PDAs (Personal Digital Assistants) and other portable electronic devices having communication capability have become fixtures of everyday life over the last several years. As they evolve, prices continue to fall while the devices' capabilities have expanded.

Such expanded capabilities include connectivity to various imaging devices such as still-imaging and video cameras. For example, there are still-image and video camera accessories that can be connected to a cellular telephone. Such accessories allow the device user to take pictures, view them on the display of cellular telephone, and send them to another cellular telephone which supports the same standard. Some devices further provide capability to send photographs taken by other electronic devices such as personal computers and the like. Further, some device manufacturers are offering portable electronic devices with built-in cameras. One drawback of using a portable electronic device with either a camera accessory or a built-in camera is the difficulty in taking a straight picture.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 illustrates an electronic device.

FIG. 2 is an electronic block diagram of the electronic device of FIG. 1.

FIG. 3 is a flowchart illustrating one embodiment of the operation of the electronic device of FIGS. 1 and 2.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

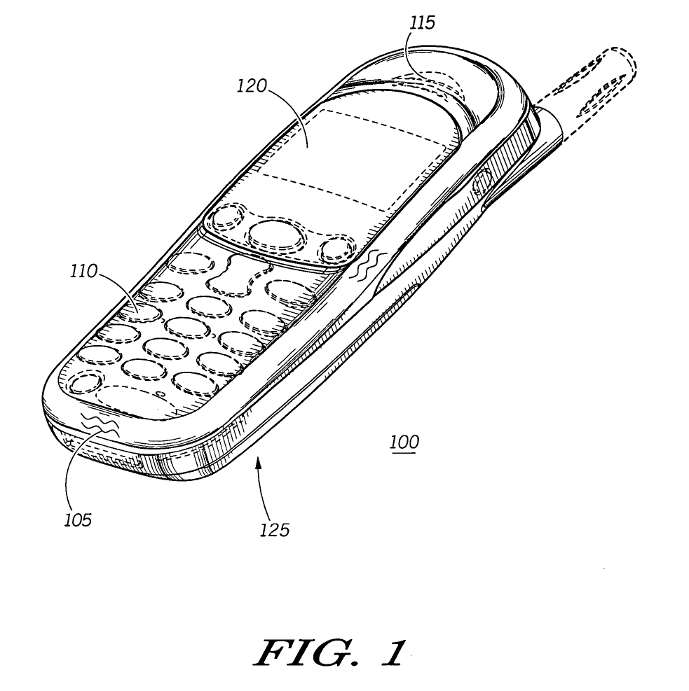

Referring to FIG. 1, an electronic device 100 is illustrated. The electronic device 100, for example, can be a cellular telephone (as illustrated), a cordless telephone, a wired landline telephone, a personal communicator, or an equivalent. Similarly, the electronic device 100 can be a PDA (personal digital assistant), a portable personal computer, or an equivalent. In the following description, the term “portable electronic device” refers to any of the devices mentioned above or an equivalent.

The electronic device 100 preferably includes a user interface (such as a microphone 105, a keypad 110, an earpiece 115, a display 120, and a housing 125). The microphone 105, for example, converts an acoustic input signal received from a voice transmission to the electronic device 100 into an electric input signal. The earpiece 115 can convert an electric output signal into an acoustic output signal transmitted from the electronic device 100 to be heard by the listener of the electronic device 100. The keypad 110 allows the user of the electronic device 100 to enter data such as phone numbers and text memos and to perform various functions within the electronic device 100. The display 120 displays data such as one or more communication messages, phone numbers, and caller identifications. The display 120 further can display graphics such as screen savers, wallpaper, gaming applications, and the like. Similarly, the display 120 can display still image and video images received by the portable electronic device, programmed into the electronic device 100, or captured by the electronic device 100 itself. The housing 125 encloses the various elements of the electronic device 100 and provides mechanical support for the device.

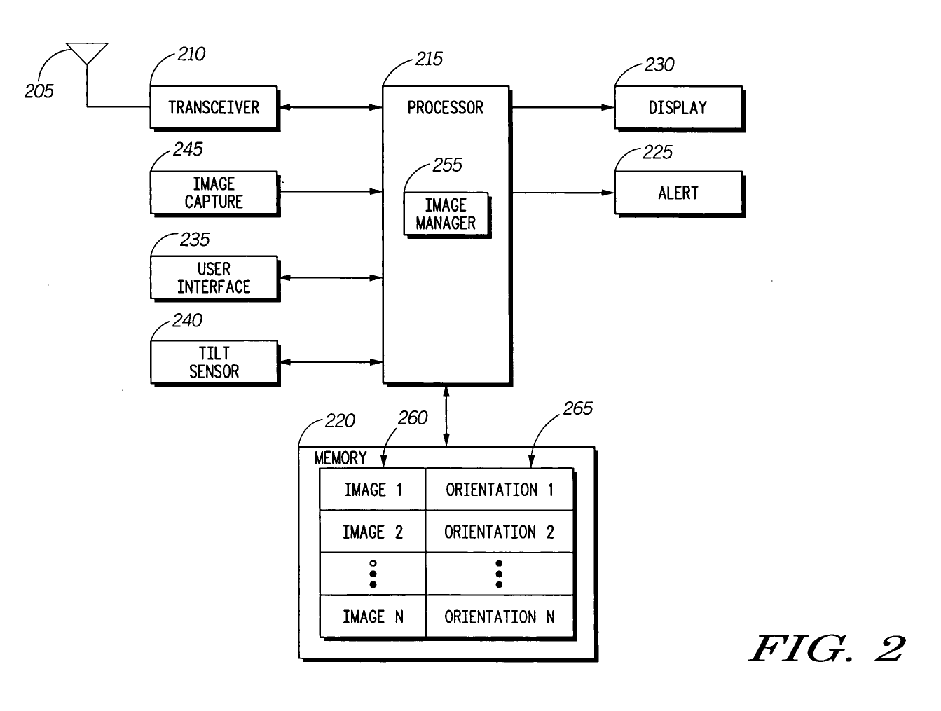

FIG. 2 is an electronic block diagram of one embodiment of the electronic device 100 of FIG. 1. Specifically, FIG. 2 illustrates a communication device 200 for use with the present invention. The communication device 200, by way of example only, can be embodied in a cellular radiotelephone having a conventional cellular radio transceiver circuitry, as is known in the art, and will not be presented here for simplicity. The invention is alternatively applied to other communication devices such as, for example, messaging devices, personal digital assistants and personal computers with communication capability, mobile radio handsets, cordless radiotelephone and the like. It will be appreciated by those of ordinary skill in the art that the communication device 200 is illustrative of one embodiment of the portable electronic device 100 and that alternative embodiments such as fixed network devices or cable broadcast devices can be used in accordance with the present invention.

As illustrated, the communication device 200 includes an antenna 205, a transceiver 210, a processor 215, a memory 220, an alert 225, a display 230, a user interface 235, a tilt sensor 240, and an image capture means 245. The antenna 205 intercepts transmitted signals such as a message, data, or a voice call from one or more communication systems and transmits signals to the one or more communication systems. It will be appreciated by those of ordinary skill in the art that one or more of the communication systems, in accordance with the present invention, can function utilizing any wireless radio frequency (RF) channel, for example, a two-way messaging channel, a mobile cellular telephone channel, or a mobile radio channel. Similarly, it will be appreciated by one of ordinary skill in the art that one or more of the communication systems can function utilizing other types of wireless communication channels such as infrared channels and/or Bluetooth channels. Similarly, it will be appreciated by one of ordinary skill in the art that one or more of the communication systems can function utilizing a wireline communication channel such as a local area network (LAN) or a wide area network (WAN) or a combination of both. The LAN, for example, can employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. The WAN, for example, can use a physical network media such as X.25, Frame Relay, ISDN, Modem dial-up or other media. In the following description, the term “communication system” refers to any of the communication systems mentioned above or an equivalent. Further, in the following description, the term “communication device” refers to any device operating within the communication systems mentioned herein or an equivalent.

The antenna 205 is coupled to the transceiver 210, which employs conventional demodulation techniques for receiving the communication signals. The transceiver 210 is coupled to the processor 215 and is responsive to commands from the processor 215. When the transceiver 210 receives a command from the processor 215, the transceiver 210 sends a signal via the antenna 205 to one or more of the communication systems. In an alternative embodiment (not shown), the communication device 200 includes a receive antenna and a receiver for receiving signals from one or more of the communication systems and a transmit antenna and a transmitter for transmitting signals to one or more of the communication systems. It will be appreciated by one of ordinary skill in the art that other similar electronic block diagrams of the same or alternate type can be utilized for the communication device 200.

Coupled to the transceiver 210, is the processor 215 utilizing conventional signal-processing techniques for processing received messages. It will be appreciated by one of ordinary skill in the art that additional processors can be utilized as required to handle the processing requirements of the processor 215. The processor 215 decodes an identification in the demodulated data of a received message, compares the decoded identification with one or more identifications stored in the memory 220, and when a match is detected, proceeds to process the remaining portion of the received message. The one or more identifications, for example, can be a unique selective call address assigned within a wireless communication system, an electronic mail address, an IP (internet protocol) address or any other similar identification.

In accordance with the present invention, the processor 215 includes an image manager 255 for manages the receipt, processing, storing, and displaying of various images. The image manager 255 receives inputs from the transceiver 210, other portions of the processor 215, the tilt sensor 240, the image capture means 245, and the user interface 235. The image manager 255 further stores images within the memory 220. The image manager 255 is adapted to determine an orientation of a desired input using the various received inputs and displaying the image and associated orientation on the display 230. It will be appreciated by those of ordinary skill in the art that the image manager 255 can be hard coded or programmed into the communication device 200 during manufacturing, can be programmed over-the-air upon customer subscription, or can be a downloadable application. It will be appreciated that other programming methods can be utilized for programming the image manager 255 into the communication device 200. It will be further appreciated by one of ordinary skill in the art that the image manager 255 can be hardware circuitry within the portable communication device 200. In accordance with the present invention, the image manager 255 can be contained within the processor 215 as illustrated, or alternatively can be an individual monitor block operatively coupled to the processor 215 (not shown).

To perform the necessary functions of the communication device 200, the processor 215 is coupled to the memory 220, which preferably includes a random access memory (RAM), a read-only memory (ROM), an electrically erasable programmable read-only memory (EEPROM), and flash memory. The memory 220, for example, includes memory locations for the storage of one or more received or transmitted messages, one or more software applications, one or more image data, and the like. The flash memory is especially useful for easy and fast information storage of the images taken by the image capture means 245 such as an integrated camera function. It will be appreciated by those of ordinary skill in the art that the memory 220 can be integrated within the communication device 200, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIN card additionally includes some form of interface for communicating with the communication device 200. The SIM card can be used to transfer a variety of information from/to the communication device 200 and/or any other compatible device. The memory 220 preferably stores one or more images 260 and one or more associated image orientation data 265.

Upon receipt and processing of a message or a call, the processor 215 preferably generates a command signal to the alert 225 as a notification that the message has been received and stored or alternatively that a call is waiting for a response. The alert 225 similarly can be utilized for other alerting notifications such as an alarm clock, expiration of a timer, or the memory 220 being at its memory storage limitations. Similarly, the alert 225 can be utilized for alerting a user of a request for a user input. The alert 225 can include a speaker (not shown) with associated speaker drive circuitry capable of playing melodies and other audible alerts, a vibrator (not shown) with associated vibrator drive circuitry capable of producing a physical vibration, or one or more light emitting diodes (LEDs) (not shown) with associated LED drive circuitry capable of producing a visual alert. It will be appreciated by one of ordinary skill in the art that other similar alerting means as well as any combination of the audible, vibratory, and visual alert outputs herein described can be used for the alert 225.

Upon receipt and processing of a message or a received call, the processor 215 preferably also generates a command signal to the display 230 to generate a visual notification. Similarly, the display 230 can be utilized as a means for providing a visual image to the user. For example, one or more still images or video images can be displayed on the display 230 for viewing by the user.

Preferably, the user interface 235 is coupled to the processor 215. The user interface 235 can include a keypad such as one or more buttons used to generate a button press or a series of button presses. The user interface 235 can also include a voice response system or other similar method of receiving a manual input initiated by the device user. The processor 215, in response to receiving a user input via the user interface 235 performs commands as required. For example, the user interface 235 can be utilized for performing functions related to the messages stored in the memory 220 such as reading, replying, or deleting one or more stored email messages. The user interface 235 further can be used to perform various functions and make various operational choices for functioning of the communication device 200. For example, the user interface 235 can be used to provide inputs to the image manager 255 for image capture by the imaging capture means 245.

The communication device 200, as illustrated, includes the image capture means 245 coupled to the processor 215. It will be appreciated by one of ordinary skill in the art that the image capture means 245 can be integrated within the communication device 200 or alternatively externally coupled to the communication device 200. The image capture means 245, for example, can be a camera including the necessary circuitry for providing camera functionality to the communication device 200. Preferably, the image capture means 245 includes functionality of a digital camera. For example, the image capture means 245 can include software and circuitry for the calculations that are made each time a picture is taken. The image capture means 245 provides functionality to preview, capture, compress, filter, store, transfer, and display the image. Typically, the image capture means 245 includes a microprocessor programmed to perform these calculations and other various functions.

The communication device 200, as illustrated, includes the tilt sensor 240 operatively coupled to the processor 215 and specifically operatively coupled to the image manager 255 within the processor 215. The tilt sensor 240 generates an artificial horizon and measures angular tilt with respect to this horizon. It will be appreciated by those of ordinary skill in the art that the tilt sensor 240 can use common sensor technologies such as accelerometer, capacitive, electrolytic, gas bubble in liquid, mercury, and pendulum. The tilt sensor 240 outputs an electrical output to the processor 215 such as analog current, digital, analog frequency or pulse, analog voltage, serial, parallel, and switched or alarm. The tilt sensor 240 can include a sensor element or chip, a sensor or transducer, an instrument or meter, a gauge or indicator, and a recorder and totalizers.

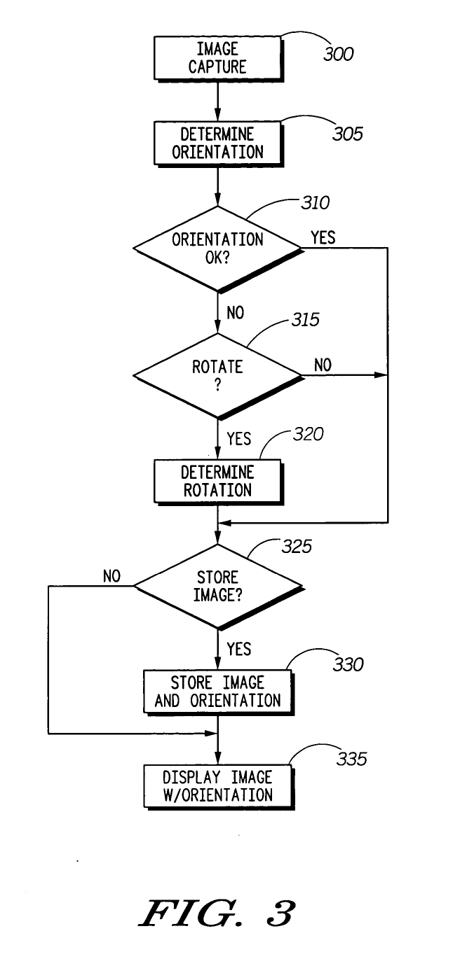

FIG. 3 is a flowchart illustrating one embodiment of the operation of the electronic device of FIGS. 1 and 2. Specifically, the operation illustrates one embodiment of the operation of the image manager 255 in accordance with the present invention. As illustrated in FIG. 3, the operation begins with Step 300 in which an image is captured by the device. For example, the image capture means 245 of the communication device 200 can capture an image in response to a user input to the user interface 235. Next, in Step 305, the operation determines the orientation of the captured image. For example, the tilt sensor 240 can determine the tilt of the communication device 200. Alternatively, the image manager 255 can include image recognition software to determine the orientation of the captured image. Next, in Step 310, the operation determines whether or not the orientation is acceptable as captured. For example, the image manager 255 can query a device user using the display 230 or the alert 225 requesting acceptance of the captured orientation. A user input to the user interface 235 can indicate acceptance or rejection of the current orientation. In one embodiment, (not shown) the image is displayed on the display 230 with the captured orientation to assist the user in determining if the orientation is acceptable. Alternatively, the image manager 255 can be adapted to automatically determine whether the orientation is acceptable using a pre-programmed set of parameters or instructions.

When the orientation is not acceptable in Step 310, the operation continues to Step 315 in which the image manager 255 determines whether or not to change the orientation, for example, by rotating the captured image. For example, the image manager 255 can query a device user using the display 230 or the alert 225 requesting a determination of whether or not to rotate the captured image. A user input to the user interface 235 can indicate a desire to rotate the captured image. In one embodiment, (not shown) the image is displayed on the display 230 with the captured orientation to assist the user in determining whether or not to rotate the captured image. Alternatively, the image manager 255 can be adapted to automatically determine whether or not to change the orientation of the captured image using a pre-programmed set of parameters or instructions. When a rotation is desired/required in Step 315, the operation continues to Step 320 in which the amount of the rotation is determined. As in previous steps, the amount of rotation can be determined by a user input to the user interface 235 or alternatively using a predetermined set of instructions or calculations.

Next, and/or when the orientation is acceptable in Step 310, and/or when no rotation is required/desired in Step 315, the operation continues to Step 325 in which the image manager 255 determines whether or not to store the captured image in the memory 220. For example, the device user may desire to store the captured image with the appropriate orientation in the memory 220 for later retrieval and/or utilization. When it is required/desired to store the image in Step 325, the operation continues to Step 330 and the image is stored along with the associated orientation. Next, and when the image is not required/desired to be stored in Step 325, the operation continues to Step 335 in which the captured image along with the appropriate orientation is displayed on the display 230.

The device and method of operation as recited herein allows a device user to capture pictures at any angle and display on a communication device display. The user doesn't need to hold the image capture means or the communication device in any specific orientation to get a perfect picture.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method of operation within an electronic device comprising the steps of:
capturing an image;
determining an orientation of the image;
changing the orientation of the image to create a rotated image; and
displaying the rotated image.

2. A method of operation as defined in claim 1 further comprising the step of:
receiving a user input for image capture prior to the capturing step.

3. A method of operation as defined in claim 1, wherein the determining step comprises the steps of:
determining the tilt of the electronic device using a sensor; and
using the tilt to determine the orientation of the image.

4. A method of operation as defined in claim 1, wherein the orientation is determined in the determining step using image recognition means.

5. A method of operation as defined in claim 1, further comprising the step of:
accepting the orientation of the image after the determining step.

6. A method of operation as defined in claim 5, wherein the accepting step comprises the steps of:
displaying the image including the orientation on a display; and
receiving a user input accepting the orientation.

7. A method of operation as defined in claim 5, wherein the accepting step comprises:
comparing the orientation to a pre-programmed set of parameters or instructions.

8. A method of operation as defined in claim 1, wherein the changing step comprises the steps of:
determining an orientation rotation of the image using a user input; and
changing the orientation using the orientation rotation.

9. A method of operation as defined in claim 1, wherein the changing step comprises the steps of:
determining an orientation rotation using a predetermined set of instructions or calculations; and
changing the orientation using the orientation rotation.

10. A method of operation as defined in claim 1, further comprising the step of:
storing the image along with the orientation rotation.

11. An electronic device comprising:
an image capturing means for capturing an image;
a sensor for determining an orientation of the image;
an image manager coupled to the image capturing means and the sensor, wherein the image manager is adapted to change the orientation of the image to create a rotated image; and
a display coupled to the image manager for displaying the rotated image.

12. An electronic device as defined in claim 11, further comprising:
a memory coupled to the image manager for storing the image and the orientation.

13. An electronic device as defined in claim 11, wherein the image manager is further adapted to:
determine an orientation rotation of the image using a user input; and
change the orientation using the orientation rotation.

14. An electronic device as defined in claim 11, wherein the image manager is further adapted to:
determine an orientation rotation using a predetermined set of instructions or calculations; and
change the orientation using the orientation rotation.
